(19) United States
(12) Patent Application Publication
(10) Pub. No.: US 2026/0195159 A1
(43) Pub. Date: Jul. 9, 2026

(54) PROTECTING A VIRTUAL MACHINE DATASTORE FROM UNAUTHORIZED ACCESS

(71) Applicant: INTERNATIONAL BUSINESS MACHINES CORPORATION, ARMONK, NY (US)

(72) Inventors: Saurabh Singh, Pune (IN); Subhojit Roy, Pune (IN); Abhishek Jain, Baraut (IN); Digambar Ingale, Kolhapur (IN); Pravin Adinath Junnarkar, Pune (IN)

(21) Appl. No.: 19/010,799

(22) Filed: Jan. 6, 2025

(51) Int. Cl. G06F 9/455

(52) U.S. Cl. CPC G06F 9/45558; G06F 2009/45583; G06F 2009/45587

(57) ABSTRACT

A storage controller stores a virtual machine identifier of a virtual machine of a hypervisor, where a storage from the storage controller has been allocated for a datastore of the virtual machine of the hypervisor. In response to receiving, by the storage controller, a request for an input/output operation on the storage that has been allocated, the storage controller determines whether the request includes the virtual machine identifier stored in the storage controller. In response to determining that the request does not include the virtual machine identifier stored in the storage controller, the storage controller prevents the input/output operation from being executed on the storage that has been allocated.

### BACKGROUND

Embodiments relate to a method, system, and computer program product for protecting a virtual machine datastore from unauthorized access.

A virtual machine is the virtualization or emulation of a computer system. A hypervisor is a type of software, firmware, or hardware that creates one or more virtual machines and allows the one or more virtual machines to run on a single physical computational device. A virtual machine may have its own operating system and applications. The hypervisor may allocate underlying physical computing resources such as central processing unit, memory, and storage to the individual virtual machines as and when required.

The computer on which a hypervisor runs the one or more virtual machines may be referred to as a host computational device. A user may create multiple virtual machines on a single host computational device and may install software applications on the virtual machines, just like on a physical computer.

### SUMMARY OF THE PREFERRED EMBODIMENTS

Provided are a method, system, and computer program product in which a storage controller stores a virtual machine identifier of a virtual machine of a hypervisor, where a storage from the storage controller has been allocated for a datastore of the virtual machine of the hypervisor. In response to receiving, by the storage controller, a request for an input/output operation on the storage that has been allocated, the storage controller determines whether the request includes the virtual machine identifier stored in the storage controller. In response to determining that the request does not include the virtual machine identifier stored in the storage controller, the storage controller prevents the input/output operation from being executed on the storage that has been allocated.

In additional embodiments, an indication that a fraudulent access is being attempted via the request is provided.

In yet additional embodiments, a data backup is performed in the storage controller, in response to providing the indication.

In further embodiments, an out-of-band communication is performed between the storage controller and a host computational device that executes the hypervisor to secure the virtual machine identifier for the storage controller.

In yet further embodiments, the storage controller uses trusted virtual machine identifiers of a plurality of virtual machines to determine whether the input/output operation is to be processed on the storage controller.

In certain embodiments, the virtual machine identifier is included in a Fibre Channel frame.

In additional embodiments, operations are performed to uniquely assign a storage disk controlled by the storage controller with the virtual machine identifier, where only legitimate input/output requests of the virtual machine are processed on the storage disk.

### BRIEF DESCRIPTION OF THE DRAWINGS

FIG. 1 illustrates a block diagram of a computing environment comprising a host computational device that is coupled to a storage controller, in accordance with certain embodiments.

FIG. 2 illustrates a block diagram that depicts how a malicious computer program may exploit a datastore to secure access to a storage volume in the storage controller, in accordance with certain embodiments.

FIG. 3 illustrates a block diagram that depicts how access to a storage volume is restricted to entities that provide a previously stored virtual machine identifier, in accordance with certain embodiments.

FIG. 4 illustrates a block diagram that depicts out-of-band communication between a host computational device and a storage controller, in accordance with certain embodiments.

FIG. 5 illustrates a flowchart for synchronizing and saving trusted virtual machine identifiers, in accordance with certain embodiments.

FIG. 6 illustrates a flowchart for input/output processing, in accordance with certain embodiments.

FIG. 7 illustrates a flowchart that shows exemplary operations, in accordance with certain embodiments.

FIG. 8 illustrates a block diagram of a system that shows certain elements that may be included in a storage controller and in a host computational device, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Virtual machines are used in many different computing environments. A virtual machine controlled by a hypervisor may store data in a datastore associated with the virtual machine, where the datastore may be created based on storage elements allocated to the virtual machine by a storage controller. A malicious computer program may perform a cyberattack on the datastore associated with the virtual machine for disrupting the computing environment or for securing unauthorized access to the computing environment.

Certain embodiments provide mechanisms in which a storage controller analyzes each input/output (I/O) operation received from virtual machines controlled by a hypervisor and determines whether the intent of the I/O operation is malicious. If the storage controller determines that the intent of the I/O operation is malicious, then the storage controller prevents the I/O operation from being executed.

Certain embodiments provide an identifier to tag a virtual machine on each Fibre Channel frame that originates from individual virtual machines, where the computing environment employs a Fibre Channel network for data communication. The storage controller uses this virtual machine identifier to uniquely identify a trusted virtual machine. If there is any I/O (read or write) operation directed to the storage controller, where the I/O operation does not carry the trusted virtual machine identifier, the I/O operation may be treated as a malicious activity and prevented from being executed. As a result, improvements are made to the operations of a computational device that executes virtual machines in a computing environment.

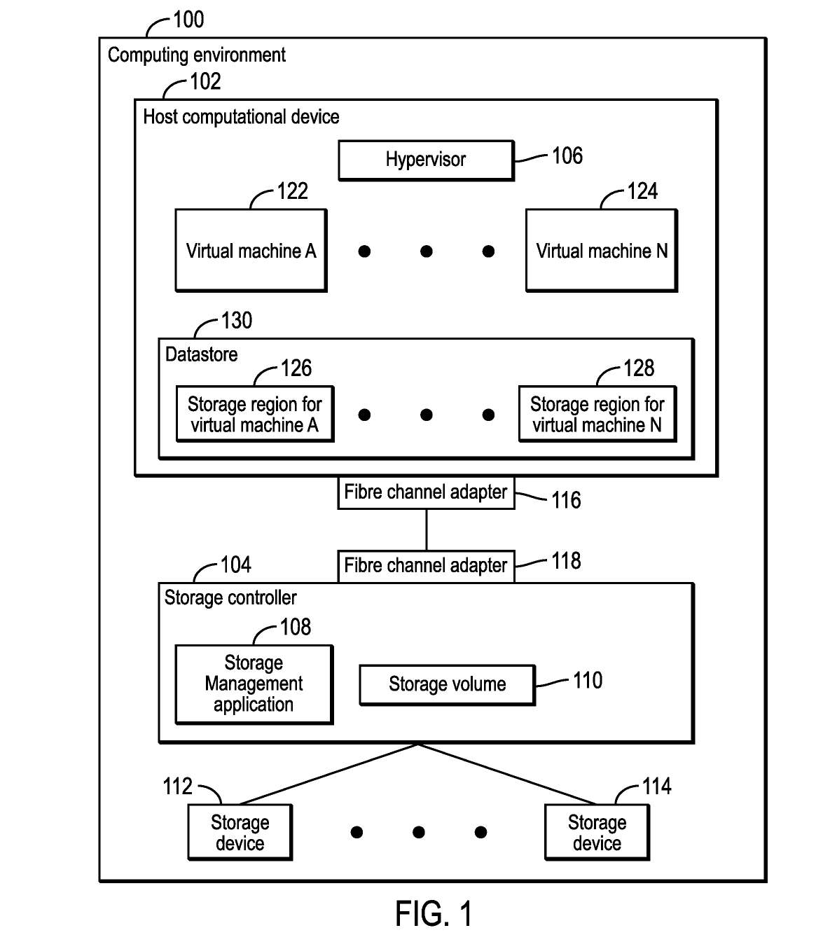

FIG. 1 illustrates a computing environment 100, in accordance with certain embodiments. In the computing environment 100, at least one host computational device 102 is coupled to a storage controller 104.

The host computational device 102 executes at least one hypervisor 106. In certain embodiments, the hypervisor 106 may be implemented in hardware, firmware, software, or any combination thereof. While one hypervisor is shown in one host computational device 102, in additional embodiments a plurality of hypervisors may execute in a plurality of host computational devices in the computing environment 100.

The storage controller 104 includes a storage management application 108 that creates at least one storage volume 110 corresponding to physical storage maintained in a plurality of storage devices 112, 114. The storage management application 108 that executes in the storage controller 104 manages storage access for the host computational device 102.

The host computational device 102 and the storage controller 104 may in certain embodiments comprise any suitable computational device known in the art such as a server, a personal computer, a laptop, a mainframe, a telephony device, etc. The host computational device 102 and the storage controller 104 may be included in any suitable network known in the art, such as, the Internet, a local area network, a wide area network, a storage area network, etc. Adapters, routers, switches, etc., may couple the host computational device 102 and the storage controller 104 to the network. For example, Fibre Channel adapters 116, 118 may couple the host computational device 102 and the storage controller 104.

A plurality of virtual machines 122. 124 may execute in the host computational device 102. The hypervisor 106 allocates storage regions 126, 128 corresponding to the virtual machines 122, 124 in the datastore 130 maintained in the host computational device 102.

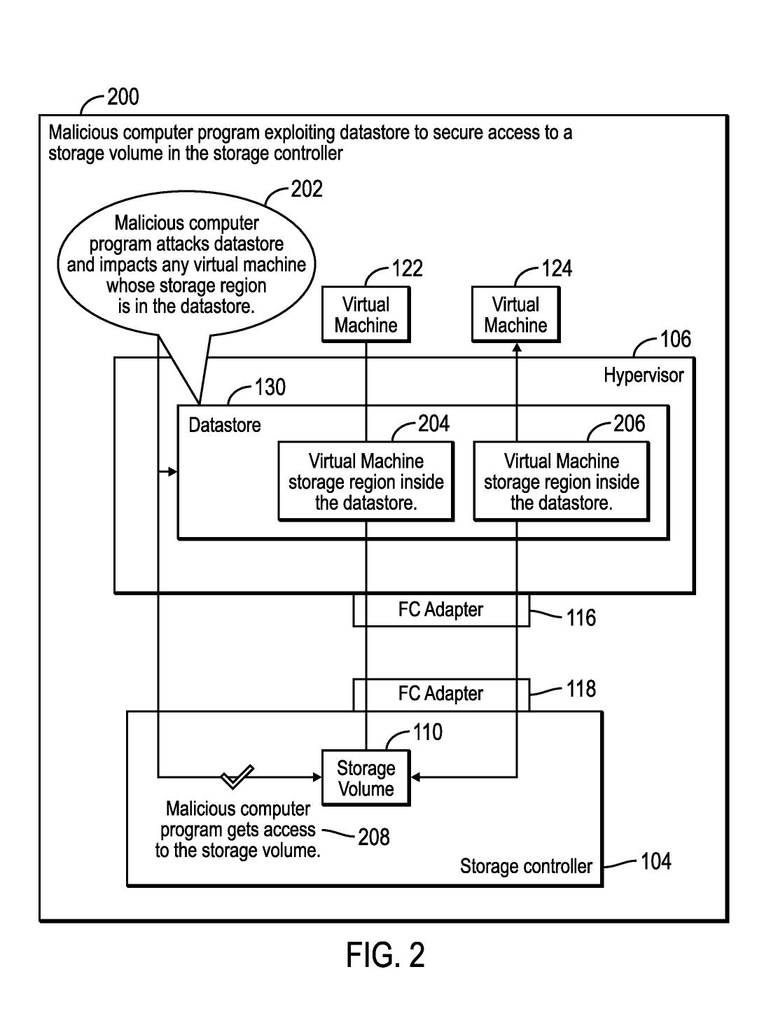

FIG. 2 illustrates a block diagram 200 that depicts how a malicious computer program may exploit a datastore 130 to secure access to a storage volume 110 in the storage controller 104, in accordance with certain embodiments.

FIG. 2 shows an example where a malicious computer program gets direct access to the datastore 130 to exploit the storage volume 110 of the storage controller 104 for read or write operations. Block diagram 200 shows (reference numeral 202) that a malicious computer program attacks the datastore 130 and this impacts any virtual machine 122, 124 whose storage region 204, 206 is in the datastore 130. As a result, the malicious program may also secure access to the storage volume 110 of the storage controller 104 which has allocated storage for the datastore 130 (as shown via reference numeral 208).

The malicious program may also initiate a ransomware attack by encrypting the datastore 130 directly. This attack may impact multiple virtual machines because a single datastore may serve a plurality of virtual machines at the same time.

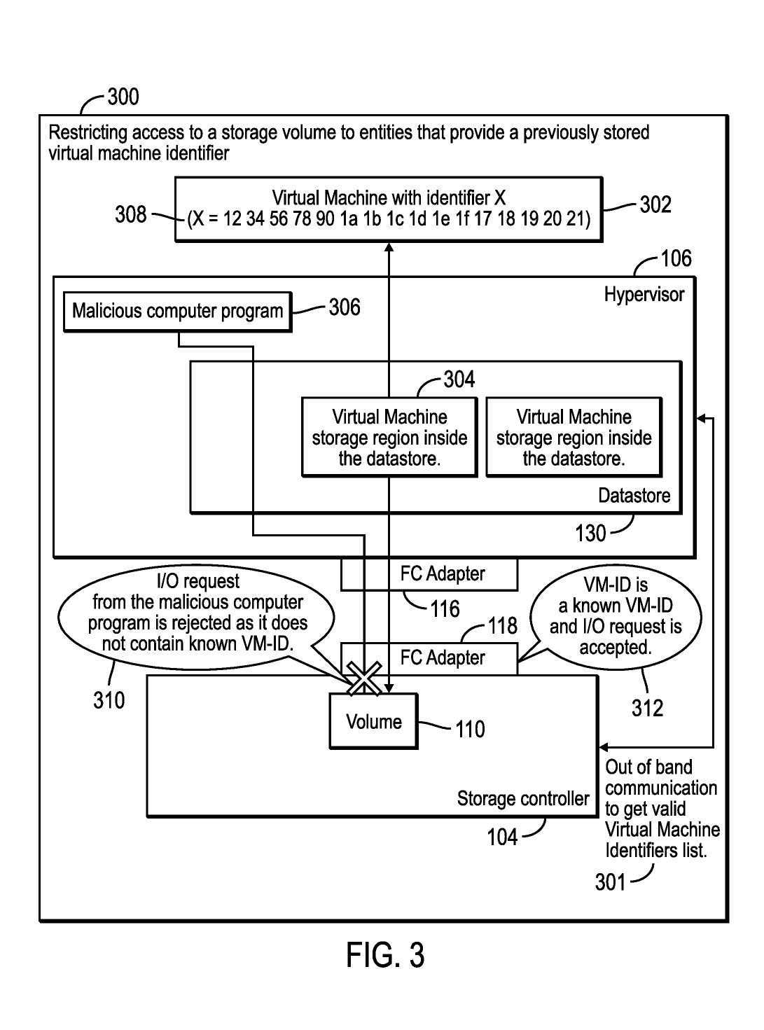

FIG. 3 illustrates a block diagram 300 that depicts how access to a storage volume 110 is restricted to entities that provide a previously stored virtual machine identifier, in accordance with certain embodiments.

To prevent cyberattacks on the datastore, certain embodiments provide a mechanism that uses existing Fibre Channel adapter implementations where a Virtual Machine identifier (VM-ID) may be injected to each packet transmitted from a virtual machine to a storage controller. The storage controller may use out of band communication mechanisms to secure a valid VM-IDs list (as shown via reference numeral 301).

For example, in FIG. 3, the storage region 304 of the virtual machine 302 maintained in the datastore 130 is enabled from the storage controller 104 using the Fibre Channel Protocol. The virtual machine 302 is provisioned with virtual volumes allocated to the storage region 304 in the datastore 130.

Using an existing Fibre Channel host bus adapter Virtual Machine Identifier feature, each virtual machine may be identified with a unique value such as a 16-byte hexadecimal value which is referred to as a virtual machine identifier. For example, in FIG. 3, the virtual machine 302 is identified with a hexadecimal value “12345678901a1b1c1d1e1f1718192021” (referred to as virtual machine identifier X 308 in FIG. 3) in each Fibre Channel frame. In a normal data path, each request from the virtual machine 302 with known Virtual Machine Identifier X, would be accepted by the storage controller 104 (reference numeral 312).

However, a malicious computer program 306 that has acquired direct access to the hypervisor 106 would not be able to perform read and write to the same datastore storage region because its request would not originate from any known virtual machine because there is no virtual machine identifier in the corresponding Fibre Channel (FC) frames for any I/O request generated by the malicious computer program 306.

If the storage controller 104 identifies any I/O request coming to its datastore’s disk with no or untrusted VM-ID, the storage controller 104 would reject the I/O request and consider that as a potential cyberattack (as shown via reference numeral 310). Hence the storage controller 104 may take proactive action and perform a backup or a snapshot.

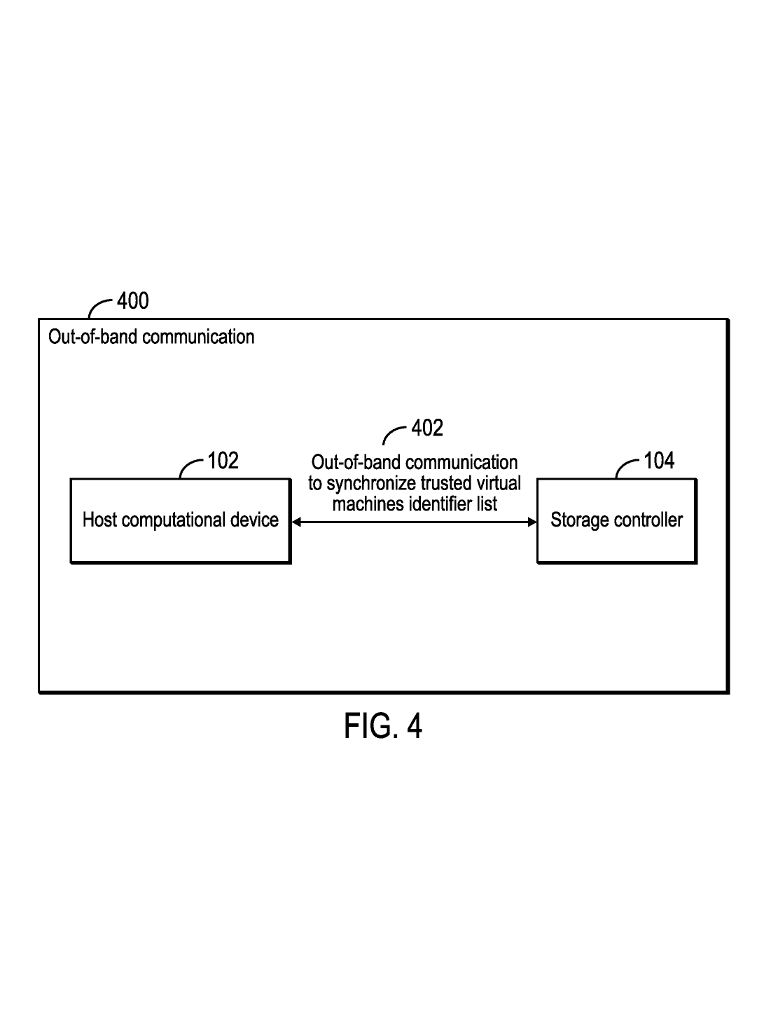

FIG. 4 illustrates a block diagram 400 that depicts out-of-band communication between a host computational device 102 and a storage controller 104, in accordance with certain embodiments. The out-of-band communication synchronizes a trusted virtual machines identifier list between the host computational device 102 and the storage controller 104 (as shown via reference numeral 402).

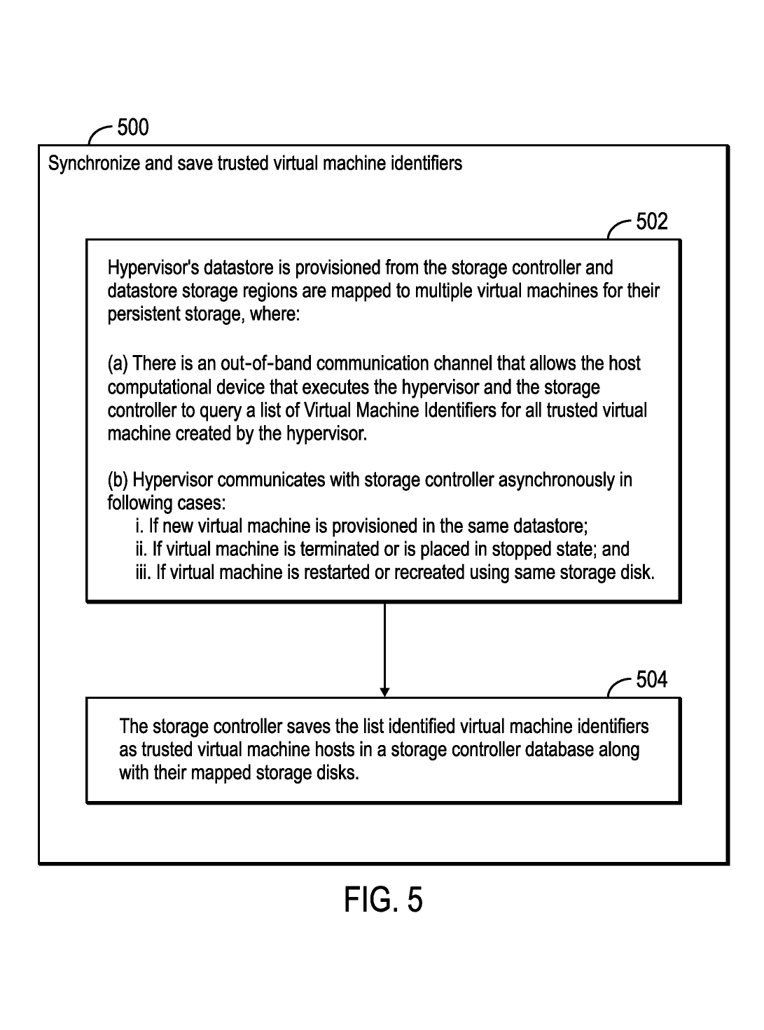

FIG. 5 illustrates a flowchart 500 for synchronizing and saving trusted virtual machine identifiers, in accordance with certain embodiments.

Control starts at block 502 in which the hypervisor’s datastore is provisioned from the storage controller and datastore storage regions are mapped to multiple virtual machines for their persistent storage. There is an out-of-band communication channel which allows a host computational device that executes the hypervisor and the storage controller to query the list of Virtual Machine Identifiers for all trusted virtual machines created by the hypervisor 106. In certain embodiments, the hypervisor 106 communicates with the storage controller 104 asynchronously if a new virtual machine is provisioned to the same datastore. The hypervisor 106 also communicates with the storage controller 104 asynchronously if a virtual machine is terminated or is placed in a stopped state, or if a virtual machine is restarted or recreated using the same storage volume.

Control proceeds to block 504 in which the storage controller saves the list identified virtual machine identifiers as trusted virtual machine hosts in a storage controller database along with their mapped storage disks.

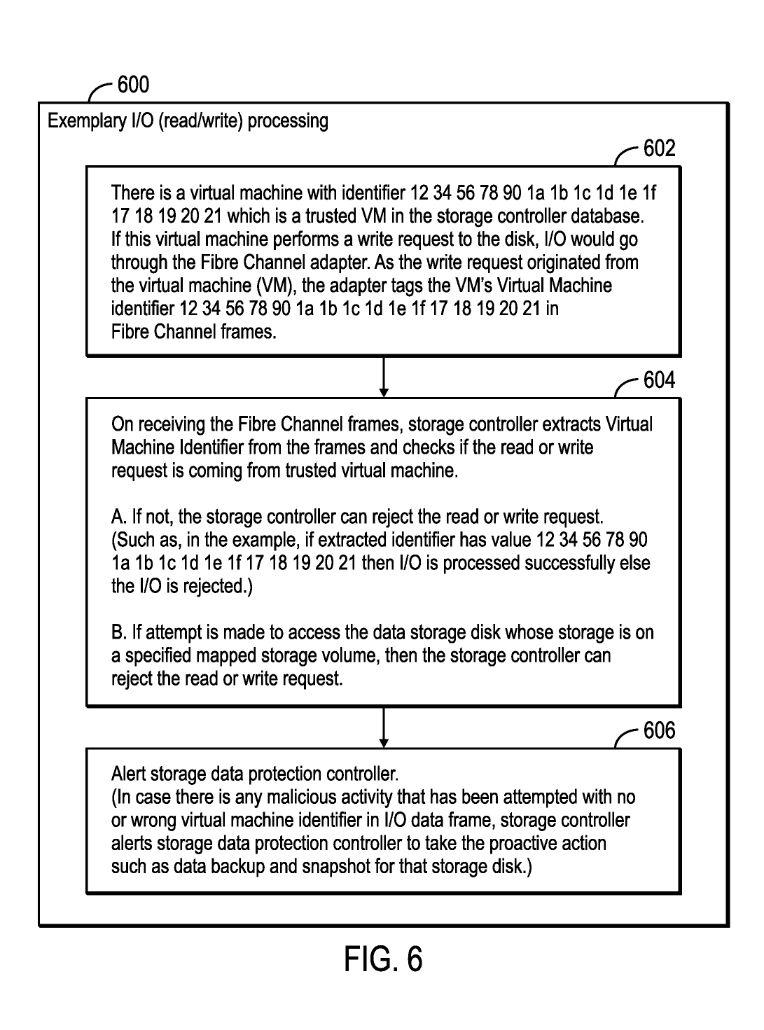

FIG. 6 illustrates a flowchart 600 for exemplary input/output (i.e., read/write) processing, in accordance with certain embodiments.

Control starts at block 602 which shows that there is a virtual machine with virtual machine identifier “12345678901a1b1c1d1e1f1718192021” which is a trusted virtual machine in the storage controller database. If this virtual machine performs a write request to the disk, the I/O would go through the Fibre Channel adapter. As the write request originated from the virtual machine (VM), the Fibre Channel adapter tags the VM’s Virtual Machine identifier 12345678901a1b1c1d1e1f1718192021 in Fibre Channel frames.

Control proceeds to block 604 in which on receiving the Fibre Channel frames, the storage controller extracts the Virtual Machine Identifier from the frames and checks if the read or write request is coming from a trusted virtual machine, and if not, the storage controller rejects the read or write request. For example, if the extracted identifier has value “12345678901a1b1c1d1e1f1718192021” then the I/O is processed successfully else the I/O is rejected.

If an attempt is made to access the data storage disk whose storage is on a specified mapped storage volume, the storage controller may reject the read or write request. The storage controller saves list identified virtual machine identifiers as trusted virtual machine hosts in the storage controller database along with their mapped storage disks.

Control proceeds to block 606 in which a process in the storage controller alerts a storage data protection controller. In case there is any malicious activity that has been attempted with no or wrong virtual machine identifier in I/O data frame, the storage controller alerts the storage data protection controller to take a proactive action such as data backup and snapshot for that storage disk.

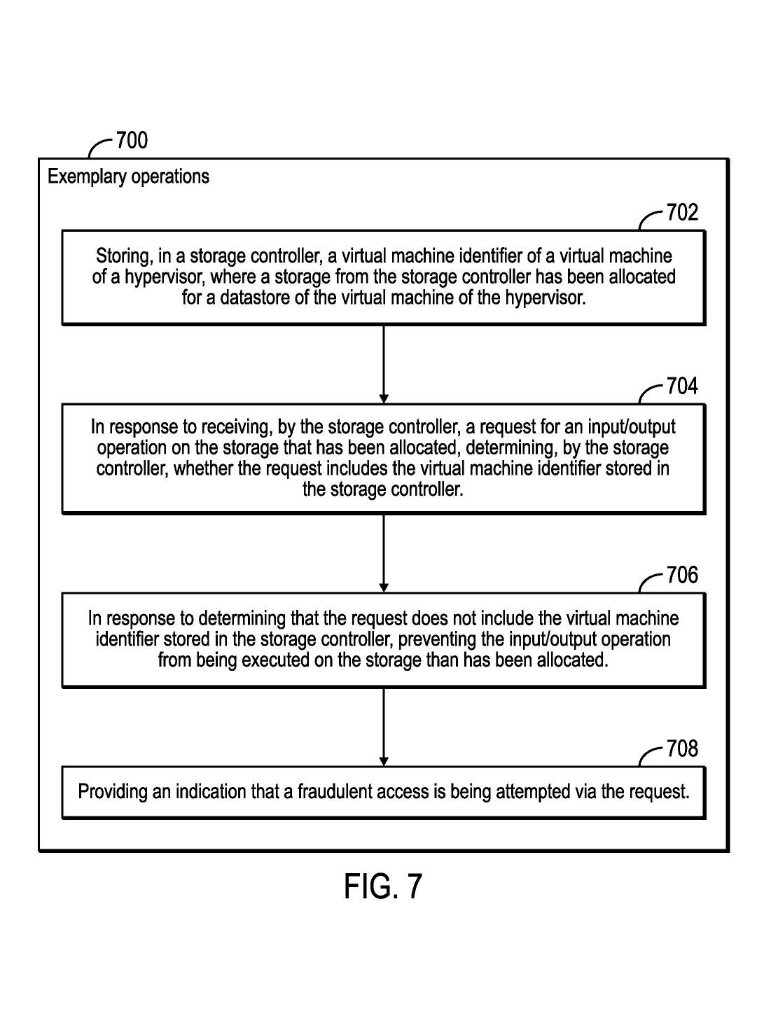

FIG. 7 illustrates a flowchart 700 that shows exemplary operations, in accordance with certain embodiments. The operations shown in FIG. 7 may be performed by the storage management application 108 that executes in the storage controller 104.

Control starts at block 702 in which a storage controller 104 stores a virtual machine identifier of a virtual machine 122 of a hypervisor, where a storage from the storage controller 104 has been allocated for a datastore 130 of the virtual machine 122 of the hypervisor 106. In response to receiving, by the storage controller 104, a request for an input/output operation on the storage that has been allocated, the storage controller 104 determines (at block 704) whether the request includes the virtual machine identifier stored in the storage controller 104.

From block 704 control proceeds to block 706 in which in response to determining that the request does not include the virtual machine identifier stored in the storage controller 104, the storage controller 104 prevents the input/output operation from being executed on the storage that has been allocated. The storage controller 104 provides (at block 708) an indication that a fraudulent access is being attempted via the request.

Therefore FIGS. 1-7 illustrate certain embodiments for protecting a virtual machine datastore from unauthorized access by using virtual machine identifiers.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

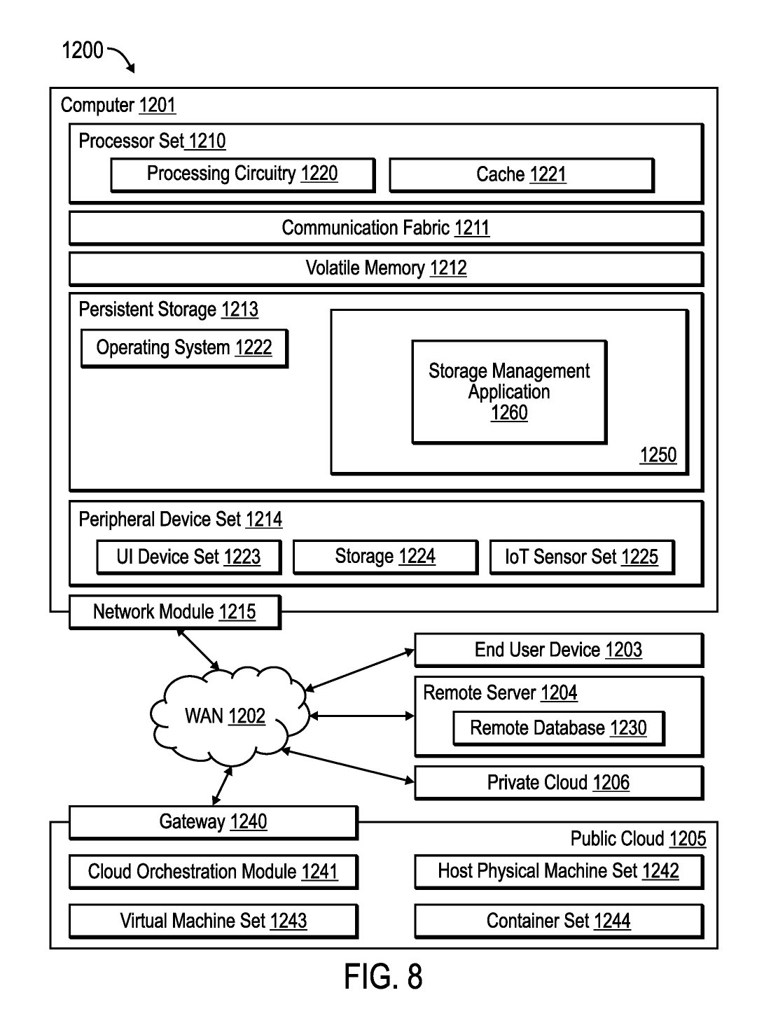

In FIG. 8, a computing environment 1200 contains an example of an environment for the execution of at least some of the computer code (block 1250) involved in performing the operations for a storage management application 1260 that performs the operations shown in FIGS. 1-7.

In addition to block 1250, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1250, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible computer 1201 may be located in a cloud, even though it is not shown in a cloud in FIG. 6. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1250 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1250 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. I/O T sensor set 1225 is made up of sensors that can be used in Internet of Things applications. For example, one sensor may be a thermometer, and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The letter designators, such as i, is used to designate a number of instances of an element and may indicate a variable number of instances of that element when used with the same or different elements.

The terms "an embodiment", "embodiment", "embodiments", "the embodiment", "the embodiments", "one or more embodiments", "some embodiments", and "one embodiment" mean "one or more (but not all) embodiments of the present invention(s)" unless expressly specified otherwise.

The terms "including", "comprising", “having” and variations thereof mean "including but not limited to", unless expressly specified otherwise.

The enumerated listing of items does not imply that any or all of the items are mutually exclusive, unless expressly specified otherwise.

The terms "a", "an" and "the" mean "one or more", unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method, comprising:
storing, in a storage controller, a virtual machine identifier of a virtual machine of a hypervisor, wherein a storage from the storage controller has been allocated for a datastore of the virtual machine of the hypervisor;
in response to receiving, by the storage controller, a request for an input/output operation on the storage that has been allocated, determining, by the storage controller, whether the request includes the virtual machine identifier stored in the storage controller; and
in response to determining that the request does not include the virtual machine identifier stored in the storage controller, preventing the input/output operation from being executed on the storage that has been allocated.

2. The method of claim 1, the method further comprising:
providing an indication that a fraudulent access is being attempted via the request.

3. The method of claim 2, the method further comprising:
performing a data backup in the storage controller, in response to providing the indication.

4. The method of claim 1, the method further comprising:
performing out-of-band communication between the storage controller and a host computational device that executes the hypervisor to secure the virtual machine identifier for the storage controller.

5. The method of claim 1, wherein the storage controller uses trusted virtual machine identifiers of a plurality of virtual machines to determine whether the input/output operation is to be processed on the storage controller.

6. The method of claim 1, wherein the virtual machine identifier is included in a Fibre Channel frame.

7. The method of claim 1, the method further comprising:
uniquely assigning a storage disk controlled by the storage controller with the virtual machine identifier, wherein only legitimate input/output requests of the virtual machine are processed on the storage disk.

8. A storage controller, comprising:
a memory; and
a processor coupled to the memory, wherein the processor performs operations, the operations comprising:
storing, in the storage controller, a virtual machine identifier of a virtual machine of a hypervisor, wherein a storage from the storage controller has been allocated for a datastore of the virtual machine of the hypervisor;
in response to receiving, by the storage controller, a request for an input/output operation on the storage that has been allocated, determining, by the storage controller, whether the request includes the virtual machine identifier stored in the storage controller; and
in response to determining that the request does not include the virtual machine identifier stored in the storage controller, preventing the input/output operation from being executed on the storage that has been allocated.

9. The storage controller of claim 8, the operations further comprising:
providing an indication that a fraudulent access is being attempted via the request.

10. The storage controller of claim 9, the operations further comprising:
performing a data backup in the storage controller, in response to providing the indication.

11. The storage controller of claim 8, the operations further comprising:
performing out-of-band communication between the storage controller and a host computational device that executes the hypervisor to secure the virtual machine identifier for the storage controller.

12. The storage controller of claim 8, wherein the storage controller uses trusted virtual machine identifiers of a plurality of virtual machines to determine whether the input/output operation is to be processed on the storage controller.

13. The storage controller of claim 8, wherein the virtual machine identifier is included in a Fibre Channel frame.

14. The storage controller of claim 8, the operations further comprising:
uniquely assigning a storage disk controlled by the storage controller with the virtual machine identifier, wherein only legitimate input/output requests of the virtual machine are processed on the storage disk.

15. A computer program product comprising a computer readable storage medium having computer readable program code embodied therewith, wherein the computer readable program code when executed by a processor performs operations, the operations comprising:
storing, in a storage controller, a virtual machine identifier of a virtual machine of a hypervisor, wherein a storage from the storage controller has been allocated for a datastore of the virtual machine of the hypervisor;
in response to receiving, by the storage controller, a request for an input/output operation on the storage that has been allocated, determining, by the storage controller, whether the request includes the virtual machine identifier stored in the storage controller; and
in response to determining that the request does not include the virtual machine identifier stored in the storage controller, preventing the input/output operation from being executed on the storage that has been allocated.

16. The computer program product of claim 15, the operations further comprising:
providing an indication that a fraudulent access is being attempted via the request.

17. The computer program product of claim 16, the operations further comprising:
performing a data backup in the storage controller, in response to providing the indication.

18. The computer program product of claim 15, the operations further comprising:
performing out-of-band communication between the storage controller and a host computational device that executes the hypervisor to secure the virtual machine identifier for the storage controller.

19. The computer program product of claim 15, wherein the storage controller uses trusted virtual machine identifiers of a plurality of virtual machines to determine whether the input/output operation is to be processed on the storage controller.

20. The computer program product of claim 15, wherein the virtual machine identifier is included in a Fibre Channel frame.
